(19) United States
(12) Patent Application Publication
(10) Pub. No.: US 2024/0420194 A1
(43) Pub. Date: Dec. 19, 2024

(54) SYSTEM AND METHOD FOR DETECTING BILLING ERRORS AND DETERMINING ALTERNATIVE SOLUTIONS FOR A PROVIDED SERVICE

(71) Applicant: Nationwide Utility Consultants, Park City, UT (US)

(72) Inventors: Parley Lance Livingston, Park City, UT (US); Thomas W. Clardy, Park City, UT (US)

(73) Assignee: Nationwide Utility Consultants, Park City, UT (US)

(21) Appl. No.: 18/742,711

(22) Filed: Jun. 13, 2024

Related U.S. Application Data
(60) Provisional application No. 63/472,778, filed on Jun. 13, 2023.

(51) Int. Cl. G06Q 30/04; G06N 5/04

(52) U.S. Cl. CPC G06Q 30/04; G06N 5/04

(57) ABSTRACT

A computer method and system, using AI, that autonomously determines overcharges on utility and other bills, and performs steps required to receive a refund and correct and improve for future billing cycles. Further, the system identifies future savings for customers that can be achieved by modifying choices of rate schedules on utility providers and tax rates. Further, process improvement instructions result in significant reduction in demand management charges. The system preferably includes Artificial Intelligence and/or machine learning, which may learn over time and adapt to the specific circumstances of a specific location or customer and continue to search for errors and savings opportunities based on rate schedules, providers, and/or legislative changes.

### CROSS REFERENCE TO RELATED APPLICATIONS

This application claims priority to U.S. Patent Application Ser. No. 63/472,778 filed Jun. 13, 2023, which is incorporated herein by reference in its entirety.

### BACKGROUND

### 1. Field

Artificial Intelligence (AI) based system and apparatus for detecting billing errors relating to a provided service, and specifically to rectifying billing errors, and more particularly to determining one or more alternative rate schedules and/or service providers relating to a provided service.

### 2. Description of Related Art

Errors in billing exist in significant regularity and represent a significant percentage of net billing. Further, customers are often not on a correct or optimal rate schedule (e.g., table of charges based on usage and time of usage (e.g., usage profile, load factor, etc.)) available from the utility.

Typically, customers of all sorts (e.g., residential and commercial) do not have the time, expertise, ability, or resources to audit their utility and other bills to uncover errors. Therefore, customers are routinely overcharged. It is estimated that 90 percent of utility customers have been overcharged and are eligible for a refund of those overcharges. However, most customers are not sophisticated and/or knowledgeable to uncover and apply for refunds on even basic overcharges. For instance, most customers do not have the ability to analyze tax and other codes regulations and laws to determine which rate schedules and tax opportunities which they make take advantage of.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, described is an AI based system configured generally for utility bill auditing (e.g., determining both future savings opportunities, and determining refunds from past incorrect overbilling), and more particularly to: collecting (ingesting) disparate bills from a plurality of utilities (or other billing partners) in multiple disparate jurisdictions; analyzing collected information for errors; analyzing collected information for comparison to other possible rate schedules and other providers for comparable services; calculating refunds due to past overcharges; and calculating potential savings from switching to other rate schedules and/or other providers.

The AI based system preferably collects and analyses customers' bills (e.g., utility and tax bills) for determining both historic overcharges and opportunities for future saving opportunities. Preferably, overcharges are compiled and presented with supporting evidence to an overcharging service provider (e.g., a utility company) accompanied with a calculated refund and correction request that is preferably in compliance with the appropriate statute of limitations for the applicable jurisdiction. Future savings may be calculated based on comparison billing calculations of switching to alternative eligible rate schedules or other utility providers. Eligibility for such is preferably determined by an AI system that collects and analyses applicable laws, regulations and codes. Savings are preferably realized by executing applicable change request forms in an automated manner.

Other illustrated embodiments may encompass: executing refund request procedures to utilities or other providers; executing rate schedule or provider change forms for future savings; calculating savings to the customer; and billing a customer a fraction of the savings the company has and will provide for them, or a flat fee, or both.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments; and

FIG. 5 is a flowchart a method of operation in accordance with one or more of the illustrated embodiments.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

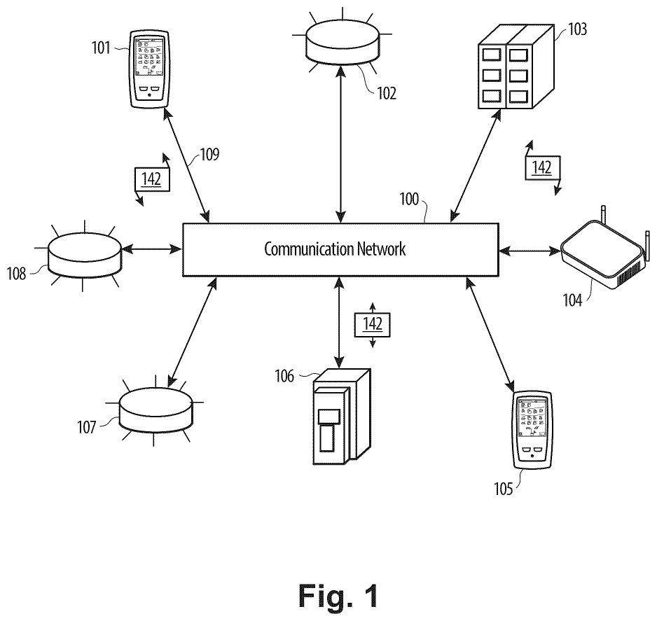

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

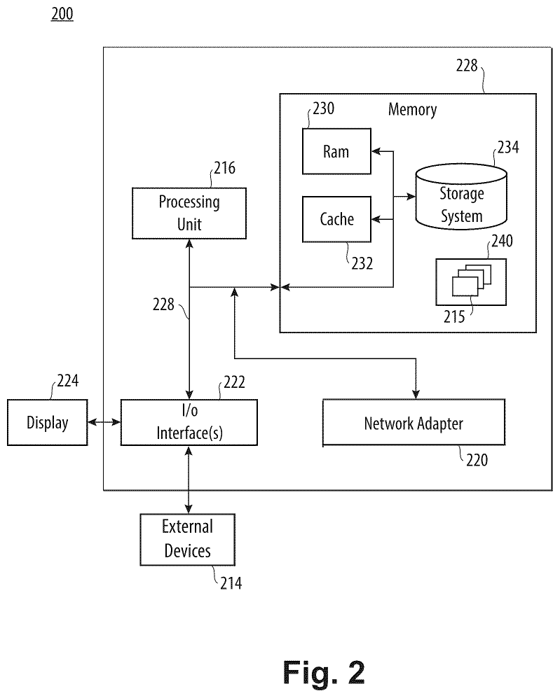

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) for determining and/or further automating one or more tasks mentioned herein relating to relating to utility bill auditing (e.g., determining both future savings opportunities, and determining refunds from past incorrect overbilling), and/or analyzing collected information for comparison to other possible rate schedules and other providers for comparable services to calculate potential savings from switching to other rate schedules, and/or other providers. Thus, preferably integrated into a network-centric billing system coupled to a plurality of external databases/data sources is an AI system (e.g., an Expert System) that implements machine learning and artificial intelligence algorithms to conduct one or more of the above mentioned task relating to one or more of a customer's service providers (e.g., utility providers). For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning.

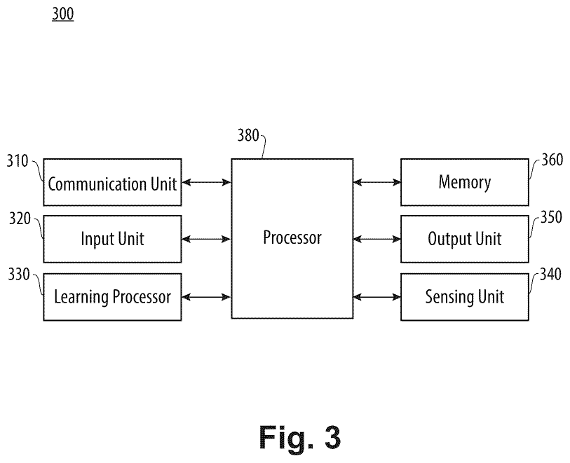

FIG. 3 illustrates an AI device 300 according to an embodiment of the present invention. The AI device 300 may be implemented by a stationary device or a mobile device, such as a smartphone, a desktop computer, a notebook, a digital broadcasting terminal, a personal digital assistant (PDA), a tablet PC, a desktop computer, and the like.

Referring to now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 370, and a processor 380. The communication unit 310 may transmit and receive data to and from external devices such as other AI devices 300a to 300e and the AI server 400 by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited utility companies regarding customer billing data, and usage data relating to a provided service. The data may further include regulatory data, statutes, laws and tax codes preferably relating to a provided service (e.g. a utility service). The data may further relate to data provided from alternative service providers and/or alternative rate schedules relating to a service from a current customer service provider. The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 370, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 370 preferably stores data that supports various functions of the AI device 300. For example, the memory 370 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 370. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 370 or the learning processor 330 or transmit the collected history information to the external device such as the AI server 400. The collected history information may be used to update the learning model.

The processor 380 may control at least part of the components of AI device 300 so as to drive an application program stored in memory 370. Furthermore, the processor 380 may operate two or more of the components included in the AI device 300 in combination so as to drive the application program.

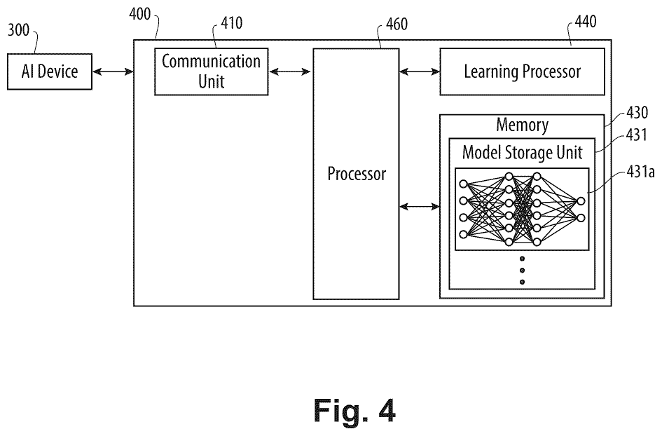

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. At this time, the AI server 400 may be included as a partial configuration of the AI device 300, and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network, or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided.

It is to be understood and appreciated that exemplary embodiments implementing one or more components of FIGS. 1-4 relate to determining errors in billing; determining errors on taxes, such as sales tax charges; onboarding customers; accessing and importing customers historical bills; parsing customer data into discrete values automatically; comparing actual values vs ideal (correct) values; import and digest ideal (correct) billing equations to compare to actual results (actual bills) and determine the delta; where the customer is due a refund, schedule and execute on automated communications that are in the format required by the refunding company or agency so that they are accepted and processed automatically; monitor that the refund occurs and is correct; process errors, objections and correspondence; determine, ingest and determine applicable laws, regulations, rules and codes pertaining to billing, including utility billing; bill customers for some percentage or another fee of the recovered or future saved funds; automatically deduct from the refund fees before, or as, or following the refund going to the customer. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

For instance, additional embodiments include analyzing the above mentioned customer billing information, consider usage amounts and time of usage; and also consider local and governing laws and code, compare customers billing to what their bills would be if they switched to a another provider—or switch do a different plan of “rate schedule” (or similar) that provides the same or a similar service. By way of example, a non-exhaustive list includes: water, sewer, storm water, natural gas, propane, energy storage, wind, solar, flywheel storage, micro nuclear, hydrothermal, or any other type of energy of any kind (e.g., including utilities and building maintenance services of any applicable type). However, and as mentioned above, a customer's billing information is not to be limited to utility bills with regard to the illustrated embodiments, as it encompasses other applicable billed services for a customer.

Other embodiments may include: automatically presenting to (and/or recommending) the client alternative services or providers (or similar) or automatically cause the client to be switched to the money saving or otherwise more optimal alternatives; monitoring to ensure that the savings on the new alternative provider or plan is correct, and preferably bill the customer some part of the savings, including any billing option that may reflect more than the actual savings for some period of time; and/or bill customers for some percentage or another fee of the recovered funds. Additional embodiments may include automatically providing periodic follow up/schedule with the customer for additional and continuing audits; and providing the above services, analyzed for tax correctness and opportunities for savings. For instance, in accordance with certain illustrated embodiments, the workflow process may include a request for historical bills on behalf of a customer to any, all, or a subset of utility or other providers/services, including execution of a request for logins to online billing platforms. For instance, a customer may execute a limited power of attorney for acquiring authorization to gain access to online billing systems (e.g., customer provides login information, or customer provides digital or paper copies, etc.) thus obviating the need for a customer to spend time conveying login information, or historical bills (which preferably includes an automated approach). Historical billing information may preferably by ingested into an AI system 400, preferably including charges, time of use, as well as rate schedules account numbers etc. Historical climate (e.g., weather) data may be correlated to energy, gas, and water usage (etc.), whereby energy to weather correlations are made and stored. Additionally, future climate models may be applied to anticipate future energy needs based on future forecasted weather. Also, a subset of eligible rate schedules and/or service providers may be determined by ingesting and analyzing laws, codes and regulations for applicable jurisdictions (which may also include brokered, co-op, power purchasing agreements, etc.). Optimal rate schedules and/or service providers may be chosen contingent on historical weather as well as predicted climatology models for a local geographic region. Also included in the process of the illustrated embodiments are calculation of refunds due from overbilling/errors, whereby refund request forms may be completed as required, in a proper format, and preferably in an automated manner. Preferably required forms for rate schedule/provider change are completed and submitted as required. Analysis as described above is may be performed periodically to ensure future errors are identified, savings applied as rate schedules, and providers change, and legal options as to which of the possibilities are available to the customer in view of changes in laws, codes, and regulations change over time, therefore ongoing analysis is provided to continue determining both overcharges and savings opportunities.

In accordance with certain illustrated embodiments, a process flow may encompass a customer selecting service providers from a list of known providers in their geographic area, wherein the system preferably executes account access, bill download, and rate schedule download, whereby the system parses and ingests data into discrete value tables. Usage/historical climate/and predictive weather (solar gain, precipitation, snowfall, temps (heating/cooling days)) are preferably factored for predicting energy and water requirements etc. Comparison of existing rate schedules and/or providers is executed to identify potential savings by switching to other rate schedules/providers/legal entities (e.g., co-op, holding company, new small entity) are preferably calculated. Applicable laws, regulations and codes are preferably considered. Also preferably determined/calculated are energy storage (battery, flywheel, etc.) options, as well as changing water service size, changing fuels, adding solar, adding energy storage (for time of use savings) with associated ROI. Potential solar footprint may be calculated based on high-res roof image. Also, tax credits, IRA fees, financing tax credits, and the like, may be calculated. Refunds due (e.g., due to overcharges) may be applied for each relevant company in the required format. Future savings may be realized by automatically filling out and sending in rate/provider change forms (and changing legal entity status as applicable). A total savings value may be generated for a customer.

It is to be appreciated and understood as the exemplary AI system will generate an atypically high volume of refund requests AND/OR rate plan changes AND/OR provider change requests, an opportunity exists for servicing utility and other service providers in managing an increased workload by providing to the utility service providers a method of automatically processing workload. It is to be further appreciated that efficiencies are achieved by extending a data pipeline from the results of servicing clients to efficiently display data for utilities and other providers in a easy to approve and process manner, whereby further efficiencies are achieved by automating refunds due, and completing rate changes, customer add/drop requests and error corrections or other savings opportunities.

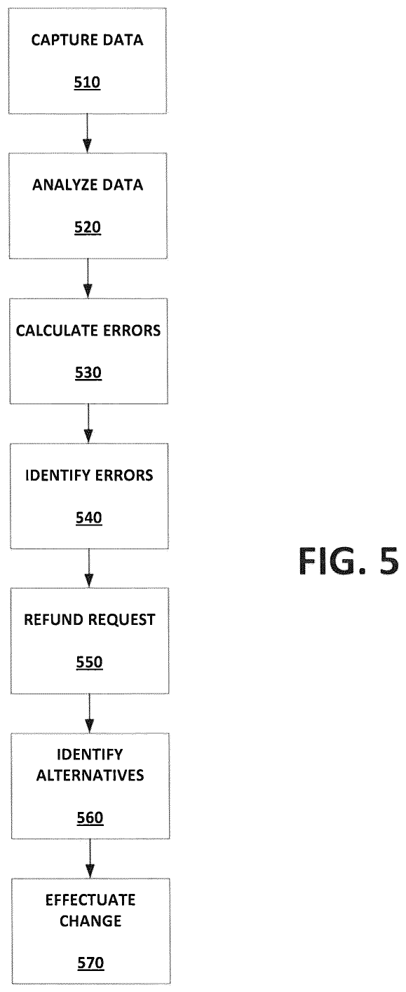

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided. With reference now to FIG. 5, shown is an exemplary process, utilizing one or more of the aforementioned communication network 100 (FIG. 1), computing device 200 (FIG. 2), AI device 300 (FIG. 3) and AI server 400 (FIG. 4), depicting one or more illustrated embodiments for determining one or more errors in a customer's billing statement, and/or determining one or more alternative service providers (and/or service rate schedules) for a customer preferably utilizing a memory 228 configured to store instructions with a processor 216/460 disposed in communication with the memory and coupled to a computer network 102, wherein the processor 216 preferably generates a learning inference model using a machine learning or deep learning algorithm for initiating one or more of the below tasks. For instance, the processor 216/460 may be configured to normalize the captured data for analysis, which may include usage of a Large Language Model (LLM) and/or Rule-based expert system. The processor is may be configured to recognize, for subsequent analysis, one or more data fields in the captured data field, wherein the one or more data fields includes one or more of: billing charges; usage information; line items and tax rates.

Starting at step 510, data is captured by the processor 216 containing information relating to the customer's billing statement relating to billed services. The billed services may preferably relate to one or more of the following services (but not to be understood to be limited thereto): water; sewer; storm water; natural gas; propane; energy storage; wind energy; flywheel storage; electricity; nuclear and micro-nuclear energy; and hydrothermal energy.

The data is preferably captured via the coupled network 102, and preferably from an external data source, wherein the external data source 214 maybe a utility company providing one or more billed services to the customer, wherein the data may be captured from external data utilizing customer login information for a account associated with the customer. Additionally, the data may be captured by data provided from the customer (e.g., customer provided billing statements). The captured data may include a request for historical billing data related to the customer and to one or more service providers providing one or more billed services to the customer. Capturing data may include capturing data relating to regulatory rules associated with customer's billing statement, wherein the regulatory rules may include one or more of: applicable laws and codes; regulations relating to billing and tax rates. The captured data may include one or more of: billing charge rates; time and/or duration of service use; service rate schedules; customer account billing account identifiers; and applied tax rates.

Next, at step 520, the captured data is analyzed to identify one or more billing errors (such as overbilling, including but not limited to identifying an incorrect tax rate and/or non-compliance with a regulation applicable to the customer). Analyzing the captured data may include determining usage amounts and/or time of usage of service associated with a customer's billing statement, wherein analyzing the captured data may include identifying the billing entity classification associated with the customer including whether the customer is: residential; commercial; small entity; non-profit; co-op; manufacturing and/or holding company.

At step 530, the processor 216/460 preferably calculates a value associated with the identified one or more billing errors, wherein calculating the value associated with the identified one or more billing errors includes calculating an ideal value that should have been charged to the customer if there was no billing error(s). Next, at step 540, the processor 216/460 preferably identifies to the customer (e.g., via any suitable means) the calculated value associated with the identified one or more billing errors, such as (but not limited to) identifying to the customer the calculated value, which may include causing to display on a user computer device the calculated value. Identifying to the customer the calculated value may include identifying to the customer the ideal value that should have been charged. Additionally the processor 216 may periodically determine if there is one or more errors in a customer's billing statement.

In accordance with further illustrated embodiments, next, at step 550, the processor 216/460 is preferably further configured to electronically initiate with one or more customer service providers a refund request associated with the calculated value associated with the one or more identified billing errors, wherein the refund request is preferably formatted for acceptance by the one or more customer service providers. It is to be appreciated that the processor 216/460 may periodically determine if the refund request was issued from the one or more customer service providers, and may be further configured to determine if there was an error in the refund request process with the one or more customer service providers. Further, the processor 216/460 may be preferably configured to respond to one or more inquiries from the one or more customer service providers relating to the refund request.

In accordance with further illustrated embodiments, next, at step 560, the processor 216/460 is preferably further configured to identify, based on the analyzed captured data (step 520), one or more alternatives means for providing a service to the customer relating to the customer's billing statement wherein the one or more alternative means provides economic benefit to the customer, and wherein analyzing the captured data includes determining the customer's usage regarding the provided service to the customer. The one or more alternative means may include (but is not to be understood to be limited to) choosing an optimal rate schedule for same service provider and/or alternative service provider. Preferably the customer's usage regarding the service provided to the customer is captured from a customer's billing statement. Analyzing the captured data may preferably include determining time of use data relating to the customer's usage of a particular service (e.g., energy). Identifying the economic benefit preferably includes determining and indicating to the customer a cost associated with each of the one or more alternative means. Identifying the one or more alterative means may also include capturing publically available information provided by one or more service providers. Identifying the one or more alterative means may also include soliciting from one or more service providers information associated with providing the service to the customer and/or conducting an analysis comparing anticipated usage future service usage by the customer for each identified alternative means, wherein the processor may utilize weighted variables for identifying the one or more alternatives means. Still further, identifying the one or more alternatives means for providing the service to the customer may include analysis of applicable regulations and/or taxes associated with changing to the one or more alternative means. identifying the one or more alternative means includes correlating historical climate data to the service to be provided to the customer. Identifying the one or more alternative means may further include correlating energy consumption to climate (weather), which may include applying future climate models to anticipate future energy needs contingent upon climate (energy).

Capturing the data containing information relating to the customer's usage regarding a service provided to the customer is preferably captured from one of either a service provider or a customer. The alternative means for providing the customer provided service may consist of one of a different service provider or a new rate schedule for a same service provider contingent upon both historical weather and predicted climatology models for a geographic region. The customer is preferably enabled to select a change to the identified one or more alternative means for providing the service to the customer, wherein enabling the customer to select a change includes displaying on a user device the determined cost associated with each of the one or more alternative means. Additionally, the processor 216/460 may periodically determine the one or more alternatives means for providing the service to the customer.

In accordance with certain illustrated embodiments, at step 570, the processor 216/460 is further configured to effectuate change to the one or more alternative means for providing the service to the customer, wherein the processor 216/460 preferably formats the change request in a proper format for effectuating the service change to the one or more alternative means for providing the service to the customer. The processor 216/460 may further be configured and operational to transmit the change request to the one or more alternative means for effectuating the service change.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer system that utilizes Artificial Intelligence (AI) techniques for determining one or more errors in a customer's billing statement, comprising:
a memory configured to store instructions;
a processor disposed in communication with the memory and coupled to a computer network, wherein the processor generates a learning inference model using a machine learning algorithm, the processor being configured to:
capture data containing information relating to the customer's billing statement;
analyze the captured data to identify one or more billing errors;
calculate a value associated with the identified one or more billing errors; and
identify to the customer the calculated value associated with the identified one or more billing errors.

2. The computer system as recited in claim 1, wherein the data is captured via the coupled computer network from at least one external data source.

3. The computer system as recited in claim 2, wherein the external data source is a utility company providing one or more billed services to the customer.

4. The computer system as recited in claim 2, wherein the data is captured directly from a customer's data source.

5. The computer system as recited in claim 3, wherein the billed services relate to one or more of the following services: water; sewer; storm water; natural gas; propane; energy storage; wind energy; flywheel storage; electricity; nuclear and micro-nuclear energy; and hydrothermal energy.

6. The computer system as recited in claim 1, wherein the captured data includes a request for historical billing data related to the customer and to one or more service providers providing one or more billed services to the customer.

7. The computer system as recited in claim 1, wherein identifying to the customer the calculated value includes generating a display on a user's computer device indicating the calculated value.

8. The computer system as recited in claim 1, wherein the processor is further configured to normalize the captured data for analysis, which includes usage of a Large Language Model (LLM).

9. The computer system as recited in claim 1, wherein the processor is further configured to electronically initiate with one or more customer service providers a refund request associated with the calculated value associated with the one or more identified billing errors, wherein the refund request is data formatted for acceptance by the one or more customer service providers.

10. The computer system as recited in claim 1, wherein analyzing the captured data further includes determining usage amounts and/or time of usage of service associated with the customer's billing statement.

11. The computer system as recited in claim 1, wherein the processor is further configured to identify, based on the analyzed captured data, one or more alternatives for providing a service to the customer relating to the customer's billing statement wherein the one or more alternatives provides economic benefit to the customer, and wherein analyzing the captured data includes determining the customer's usage regarding the provided service to the customer.

12. A computer-implemented method that utilizes artificial intelligence (AI) techniques for determining one or more alternative service providers for a customer, comprising:
a memory configured to store instructions;
a processor disposed in communication with the memory and coupled to a computer network, wherein the processor generates a learning inference model using a machine learning or deep learning algorithm being configured to:
capture data containing information relating to the customer's usage regarding a service provided to the customer;
analyze the captured data to determine the customer's usage regarding a service provided to the customer;
identify, based on the analyzed captured data, one or more alternative means for providing the service to the customer wherein the one or more alternative means provides economic benefit to the customer; and
enable the customer to select a change to the identified one or more alternative means for providing the service to the customer.

13. The computer-implemented method as recited in claim 12, wherein enabling the customer to select a change includes displaying on a user device the determined cost associated with each of the one or more alternative means.

14. The computer-implemented method as recited in claim 12, wherein capturing the data containing information relating to the customer's usage regarding a service provided to the customer is captured from one of either a service provider or a customer.

15. The computer-implemented method as recited in claim 12, wherein identifying the one or more alternative means includes capturing publicly available information provided by one or more service providers.

16. The computer-implemented method as recited in claim 12, wherein the processor utilizes weighted variables for identifying the one or more alternative means.

17. The computer-implemented method as recited in claim 12, wherein the processor is further configured to effectuate change to the one or more alternatives for providing the service to the customer.

18. The computer-implemented method as recited in claim 17, wherein the processor formats the change request in a format suitable for effectuating the service change to the one or more alternative means for providing the service to the customer.

19. The computer-implemented method as recited in claim 19, wherein the processor is further configured to electronically transmit, via a communications network, the change request to the one or more alternative means for effectuating the service change.

20. A computer-implemented method that utilizes artificial intelligence (AI) techniques for determining one or more errors in a customer's billing statement, comprising:
a memory configured to store instructions;
a processor disposed in communication with the memory and coupled to a computer network, wherein the processor generates a learning inference model using a machine learning algorithm, the processor being configured to:
capture data containing information relating to the customer's billing statement;
analyze the captured data to identify one or more billing errors;
calculate a value associated with the identified one or more billing errors;
identify to the customer the calculated value associated with the identified one or more billing errors;
analyze the captured data to determine the customer's usage regarding a service provided to the customer;
identify, based on the analyzed captured data, one or more alternatives for providing the service to the customer wherein the one or more alternatives provides economic benefit to the customer; and
effectuate a change, via a communications network, to the identified one or more alternatives for providing the service to the customer.
